(19) United States
(12) Patent Application Publication
(10) Pub. No.: US 2026/0342929 A1
(43) Pub. Date: Oct. 29, 2026

(54) MANAGEMENT SERVER, MANAGEMENT SYSTEM, AND AGGREGATION MANAGEMENT METHOD THAT CAN APPROPRIATELY AGGREGATE DATA ACCORDING TO RELATIONSHIP BETWEEN USERS

(71) Applicant: KYOCERA Document Solutions Inc., Osaka (JP)

(72) Inventor: Miwako MATSUBARA, Walnut Creek, CA (US)

(73) Assignee: KYOCERA Document Solutions Inc., Osaka (JP)

(21) Appl. No.: 19/187,232

(22) Filed: Apr. 23, 2025

(51) Int. Cl. H04N 1/34

(52) U.S. Cl. CPC H04N 1/346

(57) ABSTRACT

Provided is a management server that can appropriately aggregate data according to the relationship between users. The management server aggregates usage data related to the use of services by plurality of users. The tree classification unit classifies each of the plurality of users in a tree structure. The submission management unit permits or denies the submission of the usage data according to the relationship between the user submitting the usage data and the user acquiring the usage data, as classified by the tree classification unit. The aggregation unit outputs aggregated data aggregated only from the usage data permitted to submit by the submission management unit for presentation to the user acquiring the usage data.

### BACKGROUND

The present disclosure mainly relates to a management server, management system, and aggregation management method for managing an image forming apparatus.

As a typical technology, there is a software service model called Software as a Service (SaaS), in which a server in the cloud is accessed via the Internet or other network through a web browser or an application, and a service is used on a subscription basis or a flat-rate fee basis.

There is also a typical technology for image forming systems that charge for workflows by using the SaaS, or the like, for image forming apparatuses such as multifunctional peripherals (MFPs) that can print documents and images.

As an example of typical SaaS technology, an information processing apparatus is disclosed that includes a circuit configured to identify specific data items that form the basis of the aggregation of a report to be output, based on aggregation basis information indicating one or more data items that can be used as the basis for aggregating data included in the report among the data that can be used by the user. The circuit is further configured to output a report aggregated based on the identified specific data items.

### SUMMARY

A management server of the present disclosure is a management server that aggregates usage data related to use of a service by a plurality of users, including: a tree classification unit that classifies each of the plurality of users in a tree structure; a submission management unit that permits or denies submission of the usage data according to relationship between a user submitting the usage data and a user acquiring the usage data as classified by the tree classification unit; and an aggregation unit that outputs aggregated data, which is aggregated only from the usage data permitted to submit by the submission management unit for presentation to the user who acquired the usage data.

A management system of the present disclosure is a management system having a plurality of image forming apparatuses and a management server that aggregates usage data related to use of a service of the plurality of image forming apparatuses by a plurality of users, each of the plurality of image forming apparatuses including: a data transmission unit that transmits the usage data; and the management server including: a data acquisition unit configured to acquire the usage data from the plurality of image forming apparatuses, a tree classification unit that classifies each of the plurality of users in a tree structure, a submission management unit that submits or denies the usage data acquired by the data acquisition unit according to relationship between the user submitting the usage data classified by the tree classification unit and the user acquiring the usage data, and an aggregation unit that outputs aggregated data, which is aggregated only from the usage data permitted to submit by the submission management unit and present to a terminal for the user acquiring the usage data.

An aggregation management method of the present disclosure is an aggregation management method executed by a management server that aggregates usage data related to use of a service by a plurality of users, the method including the steps of: classifying each of the plurality of users into a tree structure; permitting or denying the submission of the usage data according to relationship between a user submitting the usage data and a user acquiring the usage data as classified; and outputting aggregated data that is aggregated only from the usage data permitted to submit for presentation to the user acquiring the usage data.

### BRIEF DESCRIPTION OF THE DRAWINGS

FIG. 1 is a system configuration diagram of an image forming system according to an embodiment of the present disclosure.

FIG. 2 is a block diagram showing a control configuration of the management server as shown in FIG. 1.

FIG. 3 is a block diagram showing a functional configuration of the image forming system according to the embodiment of the present disclosure.

FIG. 4 is a flowchart of the aggregation management process according to the embodiment of the present disclosure.

FIG. 5 is a conceptual diagram of a submission denial in the data submission management process as shown in FIG. 4.

FIG. 6 is a conceptual diagram of the data submission acceptance in the data submission management process as shown in FIG. 4.

FIG. 7 is an example of a table of aggregated data with submission denial in the aggregation process shown in FIG. 4.

FIG. 8 is an example of a table of aggregated data with submission acceptance in the aggregation process as shown in FIG. 4.

FIG. 9 is an example of a table with a changed granularity of aggregated data in the aggregation process as shown in FIG. 4.

FIG. 10 is an example of a table with aggregated data from the aggregation process as shown in FIG. 4, with the granularity of the aggregated data changed.

FIG. 11 is an example of a table with aggregated data from the aggregation process as shown in FIG. 4, with the granularity of the aggregated data changed.

FIG. 12 is an example of a table with aggregated data from the aggregation process as shown in FIG. 4, with the granularity of the aggregated data changed.

FIG. 13 is a conceptual diagram of the workflow and tasks to be aggregated in the aggregation process as shown in FIG. 4; and

FIG. 14 is an example of aggregated data aggregated by task for the workflow as shown in FIG. 13.

### DETAILED DESCRIPTION

### Embodiment

### System configuration of image forming system X

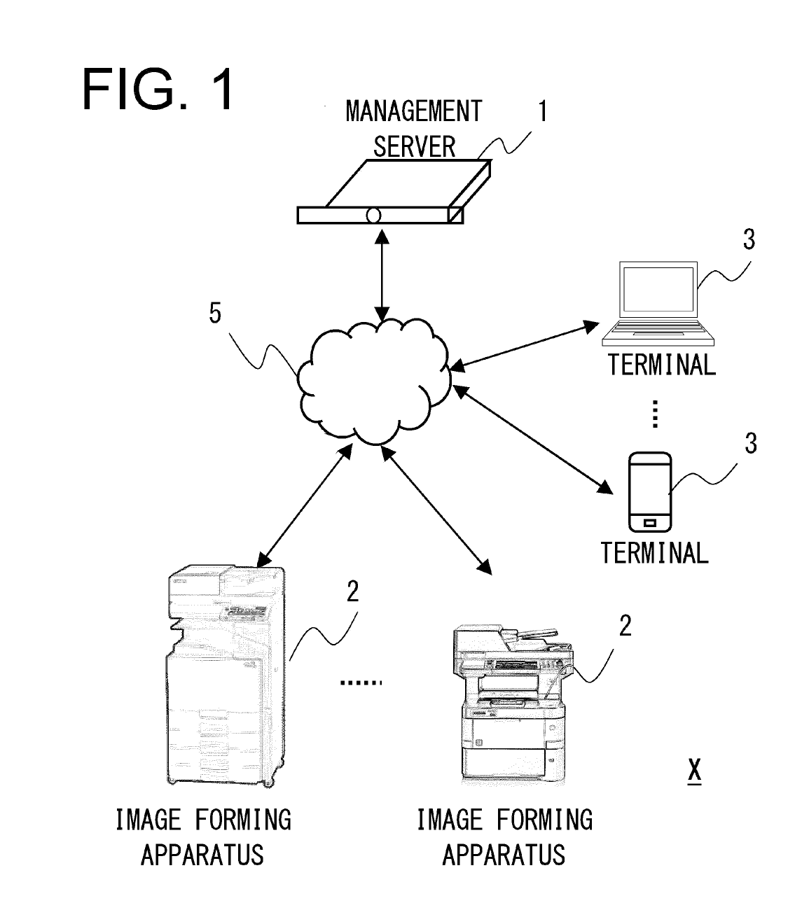

Firstly, as refer to FIG. 1, a system configuration of the image forming system X according to the embodiment of the present disclosure is explained. The image forming system X is an example of a management system according to the present embodiment.

The image forming system X of the present embodiment includes a management server 1, an image forming apparatus 2, and a terminal 3.

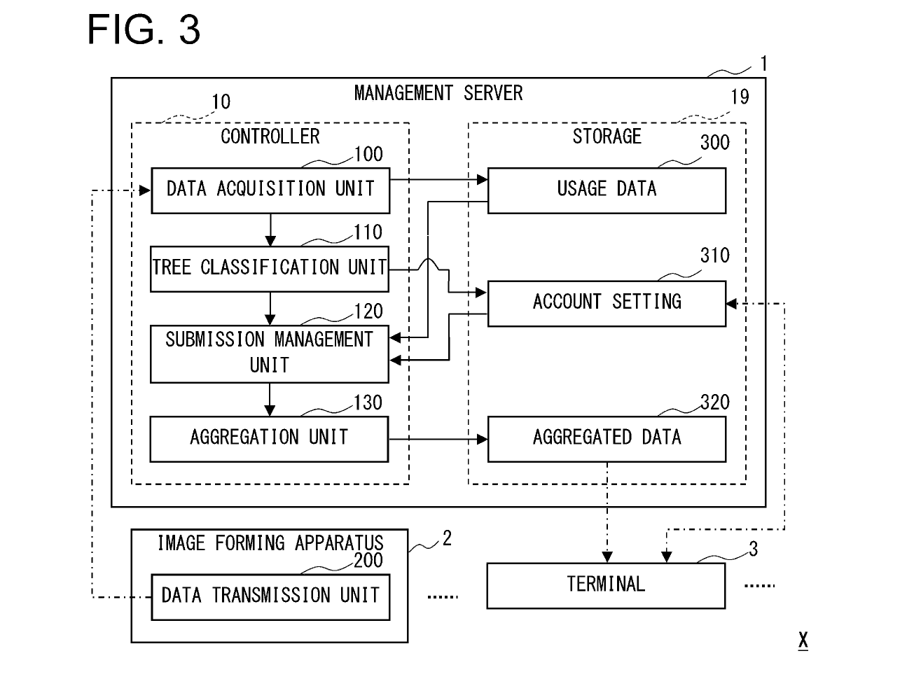

The management server 1 is an example of a server that aggregates usage data 300 (FIG. 3) related to the use of services by a plurality of users. Specifically, the management server 1 aggregates the usage data 300 by user or organization in SaaS that aggregates usage fees and usage volume, or the like.

To be more specific, in the present embodiment, an example that the service is a service to manage the image forming apparatuses 2. Therefore, the management server 1 of the present embodiment may be a so-called “fleet” server that remotely manages each image forming apparatus 2 and mainly handles billing, maintenance management, and other services.

For this reason, the management server 1 may be an information processing apparatus such as a personal computer (PC) server, a general-purpose computer, or the like, capable of executing various SaaS services (service, daemon). In addition, in the present embodiment, the management server 1 may be a server on the so-called “cloud.” Alternatively, the management server 1 may be a server on an intranet.

In the present embodiment, the management server 1 is capable of having users execute various application software (hereinafter simply referred to as an “application”) as a service. The service may include for performing optical character recognition (OCR), performing classification, sending and receiving of e-mail and various messengers (hereinafter simply referred to as “e-mail”), sending and receiving to shared folders (document boxes, storage folders), and using work or office-use document management system (DMS), or the like, and may also be related to workflows including notifications to customers. The workflow can be configured to allow plurality of combinations of each process as a task for each user. In addition, the management server 1 may be able to perform various image processing.

The image forming apparatus 2 is an information processing apparatus such as an MFP, a network scanner, a document scanner, a network facsimile, or a printer. The image forming apparatus 2 can also copy, print, scan, and fax-send a document. In the present embodiment, the above-mentioned workflow and tasks can be executed by using the image forming apparatus 2 and the user’s terminal 3.

The terminal 3 is a terminal used by the user for managing the image forming apparatus 2. The user may be a customer, a salesperson at a dealership, a service person, a support staff member, or the like. The terminal 3 may also be used by a user with management authority (hereinafter referred to as an “administrator”). The administrator may be a marketing person in a higher-ranking dealer, a manager of a fleet that provides the image forming system X, or the like.

In the present embodiment, the terminal 3 may be a PC, mobile phone, smartphone, tablet, a personal data assistant (PDA), business support terminal, dedicated terminal, or the like, provided with a controller and storage. The terminal 3 also runs various general-purpose operating systems (OSs), or the like.

In the present embodiment, terminal 3 can install a World Wide Web (WWW) browser or the dedicated application, access the management server 1, obtain reports on various usage statistics, perform setting workflows and tasks, and the like.

The network 5 is a Wide Area Network (WAN) such as the Internet or a cellular phone network, a Local Area Network (LAN), or the like. Further, the network 5 may be a voice telephone line, a dedicated line, or the like. Furthermore, the network 5 may be configured to be connected to a WAN via another network. In addition, Network 5 may form a Virtual Private Network (VPN).

### Control Configuration of Management Server 1

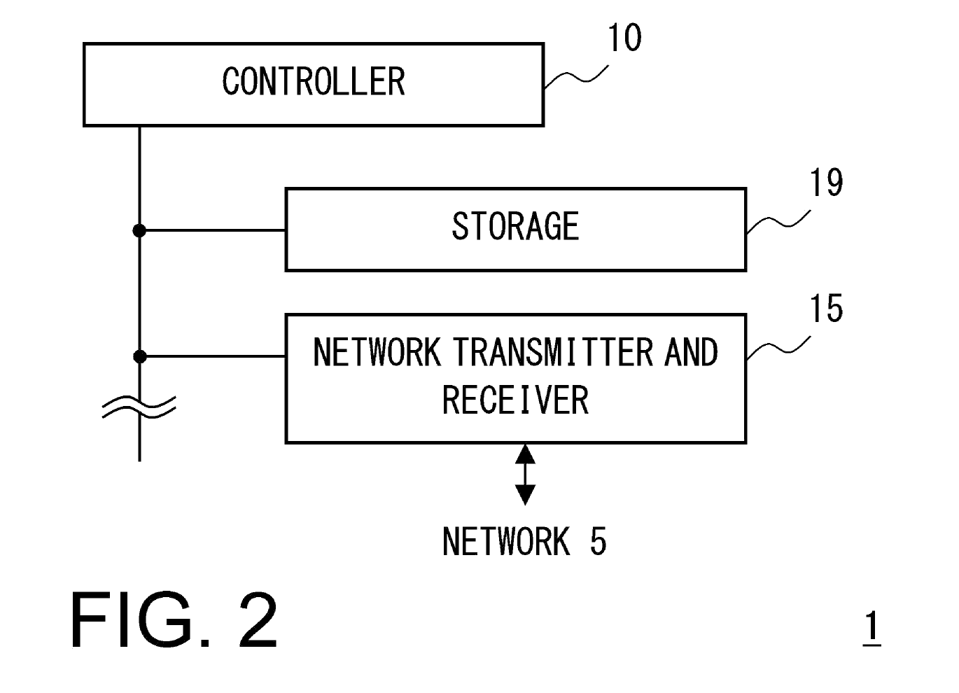

Next, as refer to FIG. 2, a control configuration of the management server 1 is explained.

The management server 1 includes a controller 10, a network transmitter and receiver 15, a storage 19, and the like. Each unit is connected to the controller 10 and is controlled by the controller 10.

The controller 10 is an information processing circuitry such as a General Purpose Processor (GPP), a Central Processing Unit (CPU), a Micro Processing Unit (MPU), a Digital Signal Processor (DSP), a Graphics Processing Unit (GPU), an Application Specific Processor (ASIC), or the like. The controller 10 reads out the control program stored in the ROM or HDD in the storage 19, and, by expanding the control program in the RAM and executing it, it can be made to operate as each part of the functional block as described later.

The network transmitter and receiver 15 is a network connection circuitry that includes a LAN board and wireless transmitter and receiver, or the like, for connecting to the network 5. The Network transmitter and receiver 15 transmits and receives data over data communication lines, and it transmits and receives voice signals over voice telephone lines.

The storage 19 is a non-transitory recording medium such as a semiconductor memory such as a Read Only Memory (ROM) or Random Access Memory (RAM), or an HDD (Hard Disk Drive). The ROM or HDD of the storage 19 stores the control program for controlling the operation of the management server 1. In addition, the storage 19 also stores the user account setting 310 (FIG. 3). Further, the storage 19 may also be allocated a space for web storage and other services for each user.

In the management server 1, the controller 10 may be formed as a single unit, such as a CPU with a built-in GPU, a chip-on-module package, or a System On a Chip (SOC). In addition, the controller 10 may also have built-in RAM, ROM, flash memory, or the like.

### Functional Configuration of Management Server 1

Here, as refer to FIG. 3, a functional configuration of the management server 1 of the image forming system X pertaining to the embodiment of the present disclosure is explained.

The controller 10 of the management server 1 is provided with a data acquisition unit 100, a tree classification unit 110, a submission management unit 120, an aggregation unit 130, and a data transmission unit 200.

The storage 19 of the management server 1 stores usage data 300, an account setting 310, and aggregated data 320.

The image forming apparatus 2 is provided with a data transmission unit 200.

The data acquisition unit 100 acquires the usage data 300 from the plurality of image forming apparatuses 2 via the network transmitter and receiver 15. The data acquisition unit 100 stores the acquired usage data 300 in the storage 19.

The tree classification unit 110 classifies each of the plurality of users in a tree structure. The tree classification unit 110 sets the classified user information in the account setting 310.

The submission management unit 120 permits or denies the submission of the usage data 300 depending on the relationship between the user submitting the usage data 300 (submitting user) and the user acquiring the usage data 300 (acquiring user) as classified by the tree classification unit 110. In this case, the submission management unit 120 denies the submission of the usage data 300 if the submitting user and the acquiring user are in a competitive relationship. Specifically, if a user, such as a distributor or wholesaler, is in a competitive relationship with an agent or retailer, the submission can be denied. Even in this case, the submission management unit 120 does not have to deny the submission for the administrator (parent provider) of the image forming system X.

The aggregation unit 130 outputs aggregated data 320, which is aggregated only from the usage data 300 submitted by the submission management unit 120, for presentation to the user acquiring the usage data 300. In the present embodiment, the aggregation unit 130 is capable of outputting the aggregated data 320 at a granularity set in accordance with the relationship. The aggregation unit 130 may set this granularity based on a viewpoint of the customer, a viewpoint of the dealer, or a viewpoint of the parent provider.

The data transmission unit 200 of the image forming apparatus 2 transmits the usage data 300 related to the use of the service by the user.

The usage data 300 is data such as metered billing and usage volume related to the use of the service by the plurality of users. In the present embodiment, the usage data 300 may be data related to billing and usage of the image forming apparatus 2. Specifically, the usage data 300 may include data such as the number of pages printed by the image forming apparatus 2 and the amount of consumables used. Further, the usage data 300 may also include data such as the amount of data sent and received from the management server 1 or the image forming apparatus 2 related to the application, the amount of data transferred, the amount of data used in the web storage, or the like. The usage data 300 may also include data such as the number of sales, the number of installations, the usage time, the number of uses, the amount of use, the sales expense (sales amount, sales, and profit) for each type of application, or the like.

Further, the usage data 300 may also include data for workflow tasks. This data may include values such as the number of workflow settings, the number of tasks executed, the number of tasks actually executed, task execution time, CPU usage, number of processes, number of threads, total data received per task, and the like.

The account setting 310 is a database that stores information such as user identification (ID), password, license, authority, permission, and the like, for each user. In addition, account setting 310 also includes information on the image forming apparatus 2 to be managed, information on the association with the image forming apparatus 2, and the like. Furthermore, account setting 310 also includes data relating to charges, including the amount of use of the SaaS service on the application. This data relating to charges may be associated with the use data 300 as described above.

In the present embodiment, the account setting 310 store a tree structure of relationships based on the affiliation information of each user. The affiliation information can be set from preset values, for example, the role of the user when using the SaaS service, such as fleet provider (provider or parent provider), wholesale or dealer (dealer), agency or retail dealer (sub-dealer), and customer. In addition, the affiliation information can also be set for sub-dealers’ sub-dealer, and the like. Furthermore, affiliation information can also be set about relationship between wholesalers, agents, dealers, customers, or the like. That means, information on which dealer or provider they belong to may be set. Here, a dealer other than the affiliated sub-dealer may be in a competitive relationship in terms of selling application. For this reason, the account setting 310 can also be set to information on such competitive relationship. Further, the tree structure of account setting 310 can be set to indicate where each user is located in the hierarchical structure.

The aggregated data 320 is data such as reports for visualizing overall usage and sales conditions. In the present embodiment, the aggregated data 320 may be a spreadsheet software table file, a PDF (Portable Document Format) file, a word processor file, or the like. In the present embodiment, the aggregated data 320 can be set to output at a granularity level from the customer’s viewpoint or the dealer’s viewpoint. The details of the granularity are described later.

Here, the controller 10 of the management server 1 is made to function as the data acquisition unit 100, the tree classification unit 110, the submission management unit 120, the aggregation unit 130, and the data transmission unit 200 by executing the control program stored in the storage 19. Further, the above-mentioned units of the management server 1 become hardware resources that execute the image forming method of the present disclosure.

In addition, the image forming apparatus 2 can also be made to function as the data transmission unit 200 by having the controller execute the control program stored in the storage.

Furthermore, some or any combination of the above-mentioned functional configurations may be configured in hardware or circuitry using ICs, programmable logic, Field-Programmable Gate Arrays (FPGAs), or the like.

### Aggregate management process by management server 1

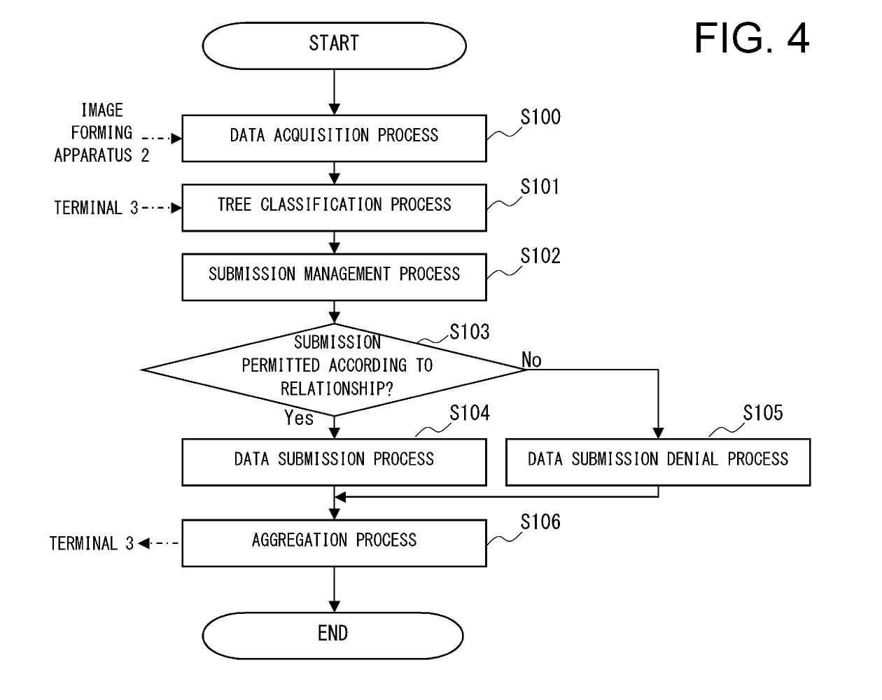

Next, as refer to FIGS. 4-8, the aggregation management process performed by the management server 1 according to the embodiments of the present disclosure is explained.

In the aggregation management process of the present embodiment, at first, the usage data 300 is acquired. Then, each of the plurality of users is classified in a tree structure. Then, depending on the relationship between the user submitting the classified usage data 300 and the user acquiring the usage data 300, the submission of the usage data 300 is permitted or denied. Then, in order to present it to the user acquiring it, the aggregated data 320, which is an aggregation of only the submitted usage data 300, is output.

In the present embodiment, the aggregation management process is executed by the controller 10 in the management server 1, which cooperates with each unit and uses hardware resources to execute the program stored in the storage 19. In addition, the controller of the image forming apparatus 2 also executes the program stored in the storage, cooperating with each unit and using hardware resources.

With referring to the flowchart in FIG. 4, the details of the aggregation management process are explained as follows.

### Step S100

Firstly, the data acquisition unit 100 performs data acquisition process.

In this processing, the data acquisition unit 100 accesses each of the plurality of image forming apparatuses 2, which is managed, via the network 5 and causes the data transmission unit 200 to transmit the usage data 300. Alternatively, the data transmission unit 200 may periodically transmit the usage data 300 by the setting set in the time when the image forming apparatus 2 is installed or maintained.

Thus, the data acquisition unit 100 acquires the usage data 300 from each image forming apparatus 2, associates the usage data 300 with the user ID, and stores it in the storage 19.

Furthermore, the data acquisition unit 100 may acquire data relating to the use of the dedicated application from the terminal 3, set it to data relating to charges in the account setting 310, and reflect this in the usage data 300.

### Step S101

Then, the tree classification unit 110 performs the tree classification process.

The tree classification unit 110 classifies each of the plurality of users in a tree structure. Specifically, the tree classification unit 110 generates the tree structure based on the affiliation information in the account setting 310 and stores it in the account setting 310. At this time, the tree classification unit 110 also sets the relationship between the user submitting the usage data 300 and the user acquiring the usage data 300. Specifically, the tree classification unit 110 can also set a competitive relationship for the relationship other than a direct subordinate (affiliated) relationship where one level is connected in a top-bottom (parent-child) manner by referring to the generated tree structure. In this case, the tree classification unit 110 sets the relationship between each user as a competitive relationship, such as the relationship between a retailer or wholesaler (dealer) and a distributor or retailer (sub-dealer,) or the relationship between a dealer and a customer. This relationship setting can be changed or set by the user or the administrator. Therefore, even if it is a subordinate relationship, it may be possible to set it as the competitive relationship.

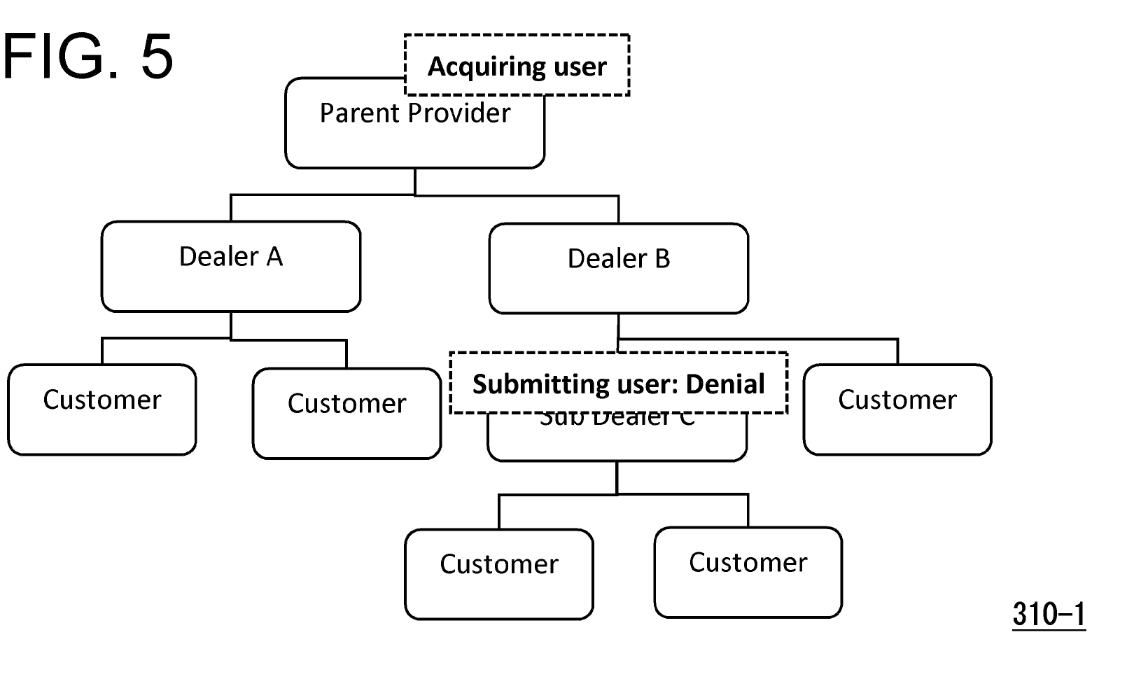

FIG. 5 shows an example of a tree structure in which each user is set in a hierarchical structure in the account setting 310-1. In this example, there is a dealer “A” and a dealer “B” under the parent provider, and there is a subordinate sub-dealer “C” under the dealer “B.” In addition, each customer is connected with the lower level.

### Step S102

Then, the submission management unit 120 performs the submission management process.

The submission management unit 120 submits or denies the usage data 300 according to the relationship between the user submitting the usage data 300 and the user acquiring the usage data 300.

The submission management unit 120 refers to the account setting 310 and, if the users are not in the competitive relationship, submits the usage data 300 for aggregation. For example, the submission management unit 120 may submit the usage data 300 from a lower-level user by setting it to be viewable to the aggregation of a higher-level user in the storage 19. Conversely, if the users are in the competitive relationship, the submission management unit 120 may deny to submit this usage data 300 by setting it to be unviewable for the aggregation to the users in the competitive relationship. In other words, for example, it is possible to set the lower-level user in the hierarchical relationship to deny to be the subject of aggregation.

More specifically, the submission management unit 120 can deny to provide the usage data 300 in order to prevent the distributor (sub-dealer) from being known to the wholesaler (dealer) to which it does not belong. This is because, in the case of wholesalers, the wholesaler and the sub-dealer under its control may be competitors, and there may be a sub-dealer who does not want to disclose the customer information. Otherwise, there may be cases where customer information is not easily disclosed to a distributor, and there may be cases where submission is denied even in the relationship between the customer and the agent.

FIG. 5 shows an example in which the sub-dealer “C” (submitting user) has set up to deny for submission the usage data 300 at the time of outputting the aggregation to the parent provider (acquiring user). This is to prevent the other dealer “A” from knowing the usage data 300.

However, in cases where there is no such relationship, the submission management unit 120 may submit the usage data 300 regardless of the relationship settings in the account setting 310. For example, users who are directly affiliated to each other in a hierarchy, or where the parent provider has special administrative authority.

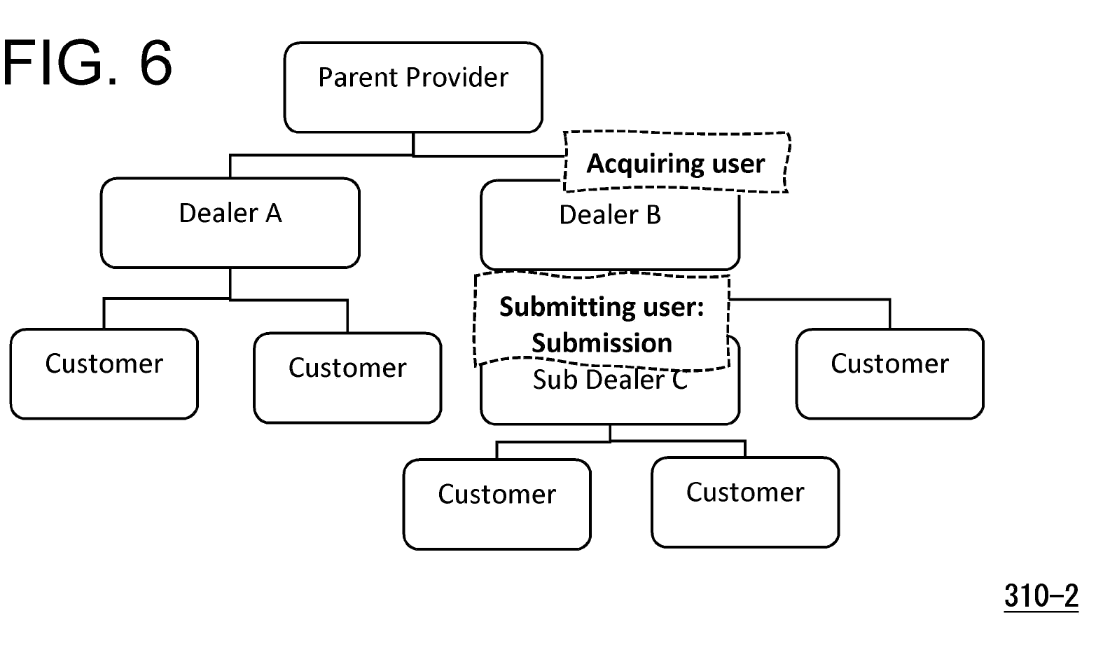

FIG. 6 shows an example in which sub-dealer “C” submits the usage data 300 to the dealer “B.” In this example, as a relationship setting, the sub-dealer “C” is under the control of the dealer “B,” so the submission is permitted. Therefore, the usage data 300 of the sub-dealer “C” is submitted.

### Step S103

Then , the submission management unit 120 determines whether the data has been permitted for submission according to the relationship or not. If the submitted data 300 is permitted to submit, that means viewable in the storage 19, the submission management unit 120 determines it to be “Yes.” If the data has not been submitted, or if the submission has been denied, that means unviewable in the storage 19, the submission management unit 120 determines it to be “No.”

If it is “Yes,” the submission management unit 120 proceeds to step S104.

If it is “No,” the submission management unit 120 proceeds to step S105.

### Step S104

If the data is permitted to submit, the submission management unit 120 performs the data submission process.

The submission management unit 120 sends the usage data 300 of the submitting user to the aggregation unit 130 for aggregation by the acquiring user.

In the example of FIG. 6, the usage data 300 is sent to the aggregation unit 130.

### Step S105

If the data is denied to submit, the submission management unit 120 performs the data submission denial process.

The submission management unit 120 does not send the user’s usage data 300 to the aggregation unit 130 as it cannot be viewed.

In the example in FIG. 5, in this way, the usage data 300 of sub-dealer “C” is not submitted for aggregation by dealer “B,” but most of other usage data 300 is sent to the aggregation unit 130.

### Step S106

Here, the aggregation unit 130 performs the aggregation process.

The aggregation unit 130 outputs the aggregated data 320, which is the aggregated data of only the usage data 300 submitted by the submission management unit 120 and presents it to the terminal 3 on the acquiring user.

The aggregation unit 130 outputs the aggregated data 320 as a report with the granularity of the desired unit for users such as customers and dealers who cannot aggregate data externally. In this way, it is possible to visualize the overall usage and sales status.

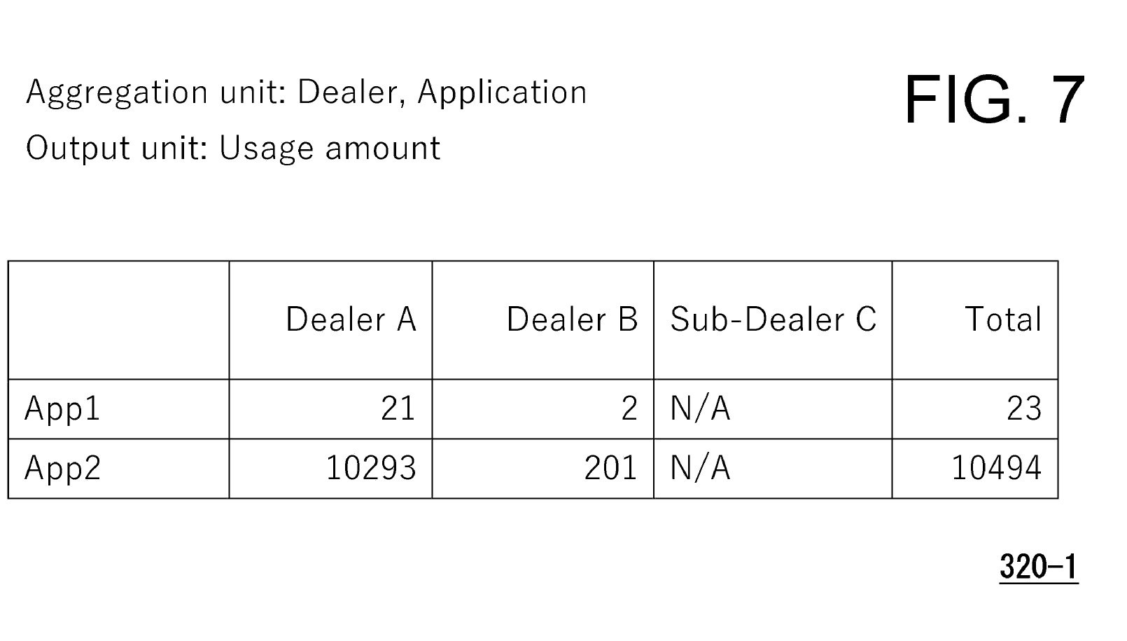

FIG. 7 shows aggregated data 320-1, which is a report for a parent provider based on the example in FIG. 5. In this example, the aggregation unit is for dealers, the output unit is the amount of use of the application, and the granularity is shown by the number of uses. Here, aggregated data 320-1 shows an example in which the parent provider has aggregated the number of uses of “App 1” and “App 2” for dealers’ “A” and “B.” However, in this example, because the data for sub-dealer “C” has been denied for submission, the relevant column is “N/A,” and the usage amount is not shown in the report. Therefore, the total is also the value excluding the usage amount of sub-dealer “C.”

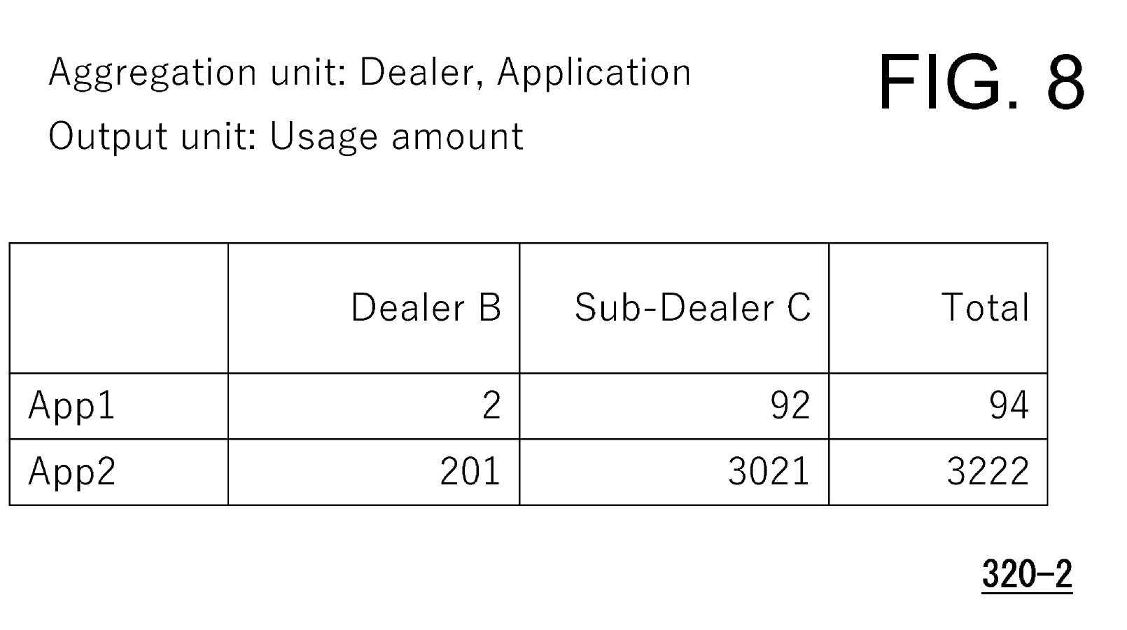

FIG. 8 shows the aggregated data 320-2, which is a report for dealers based on the example in FIG. 6. The aggregation unit, output unit, and granularity of the report are the same as the example in FIG. 7. However, in this example, the results of the aggregation by using the submitted usage data 300 of sub-dealer “C” are shown.

Here, the aggregation unit 130 can be set based on the viewpoint of a customer or a dealer. More specifically, in the case of the viewpoint of the customer, the aggregation unit can be set for users, groups, apparatuses, organizations, and groups or integrated units specific to each service. In this case, cross-tabulation is also possible. Further, as an output unit setting, it is possible to set the output granularity in terms of usage volume. In this case, it is possible to set bytes (B), gigabytes (GB), terabytes (TB), petabytes (PB), or the like. Furthermore, as an output unit, it is also possible to output as a percentage of the total. In addition, as an output unit, it is also possible to output as a breakdown of the total amount.

On the other hand, from the viewpoint of the dealer, it is possible to set the aggregation unit by lower-level provider, direct sales customer, apparatus such as models and series, and groups or integrated units specific to each service. In this case, cross-tabulation is also possible. In addition, in the setting of the output unit, it is possible to set B, GB, TB, PB, or the like, as the granularity setting for output by usage unit. As the output unit, it is also possible to output as a percentage of the total and to output as a breakdown of the total amount.

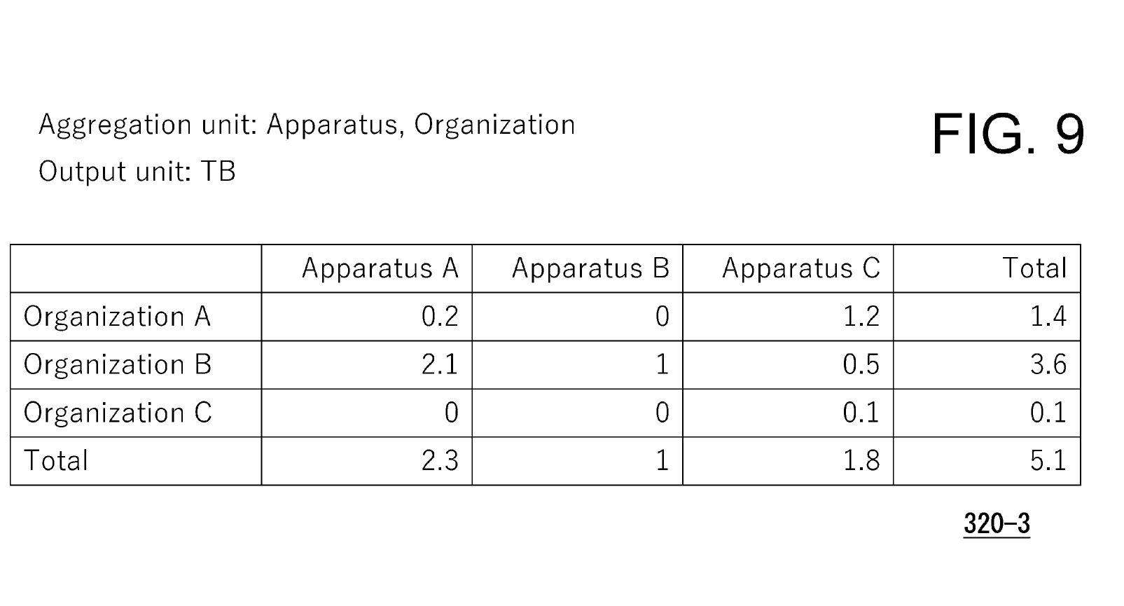

FIG. 9 shows an example of output as aggregated data 320-3 when providing a SaaS plan for web storage, such as “flat rate of 10,000 yen (JPY) up to 100 GB” and “additional charge of 2,000 yen (JPY) for each additional 10 GB.” In this example, the output unit is TB, and the aggregation unit is apparatus and organization, from the customer’s point of view. Here, the TB of the usage amount of apparatus “A” to “C” is aggregated and output for organizations “A” to “C.”

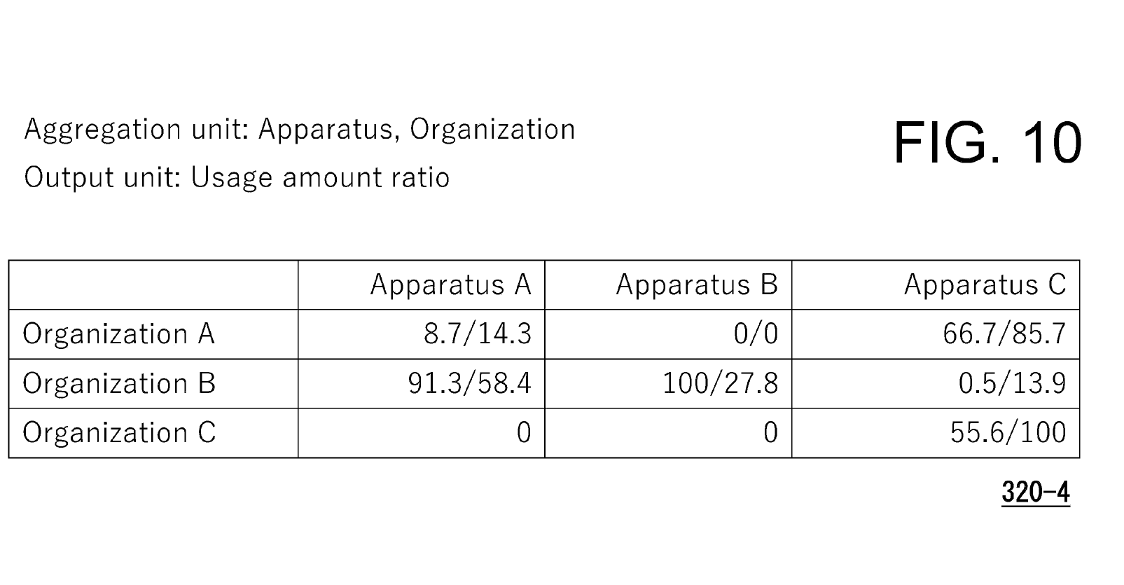

FIG. 10 is an example of outputting as aggregated data 320-4, which is the same data as aggregated data 320-3, with the aggregation unit as apparatus and organization, and the output unit as the usage amount ratio. In this case, it is possible to understand which organizations are using the apparatus.

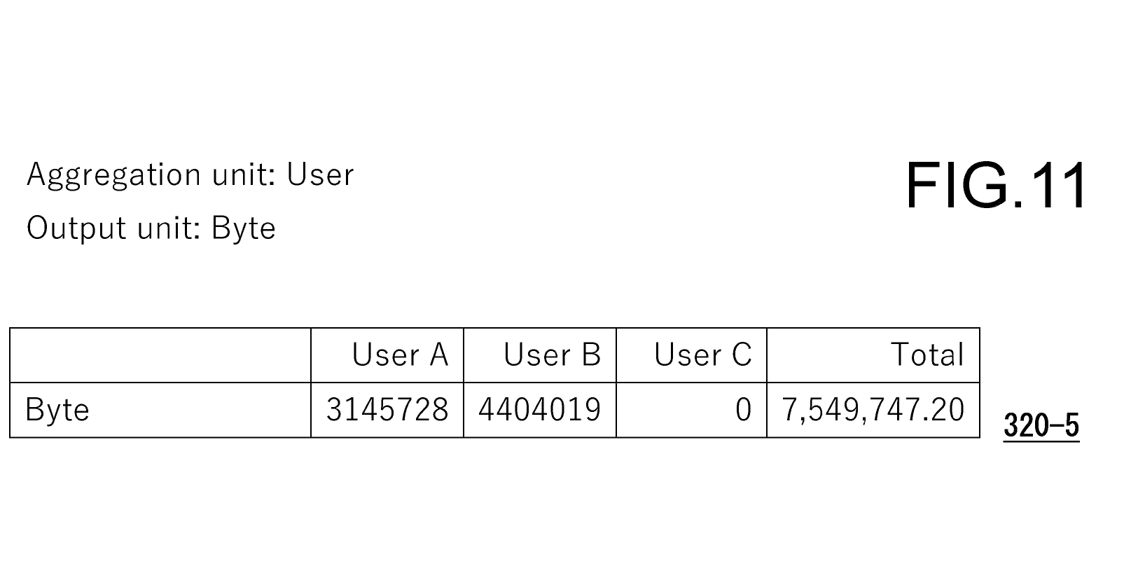

FIG. 11 is an example of output as aggregated data 320-5 for the same data as the aggregate data 320-3 and the aggregate data 320-4, with the aggregation unit set to user and the output unit set to Byte (B), from the viewpoint of the customer. Here, it is possible to check which users are using the data with a high degree of granularity.

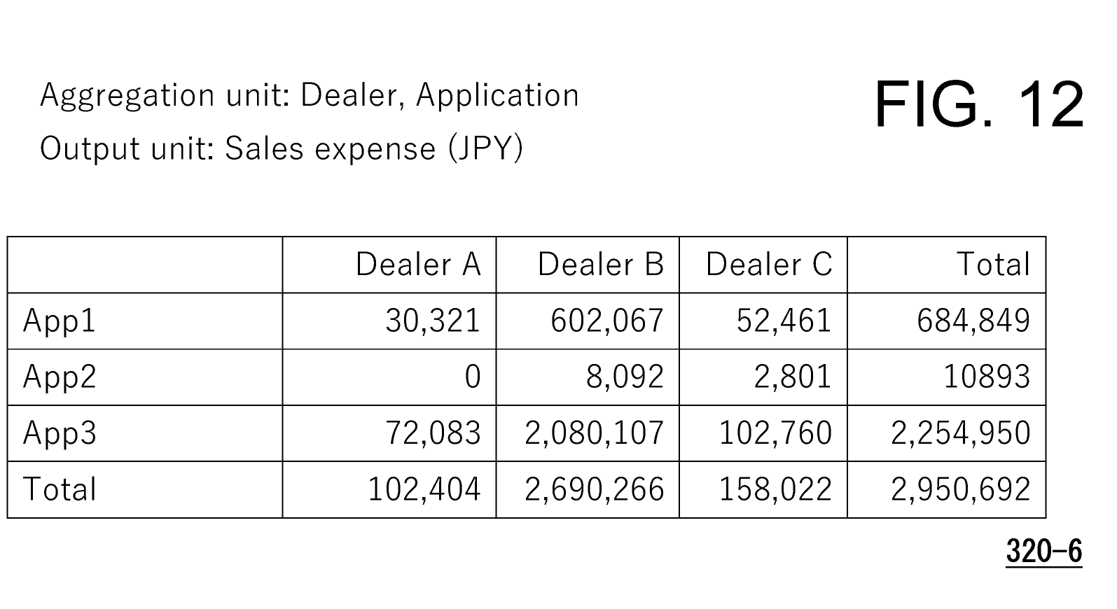

FIG. 12 shows an example of output as aggregated data 320-6 from the viewpoint of the dealer, where the aggregation unit is “dealer” and “application,” and the output unit is “sales expense (JPY).” In this example, it is possible to check which dealers are selling how much in terms of applications.

Alternatively, the aggregation unit 130 can also perform aggregation for executed workflows.

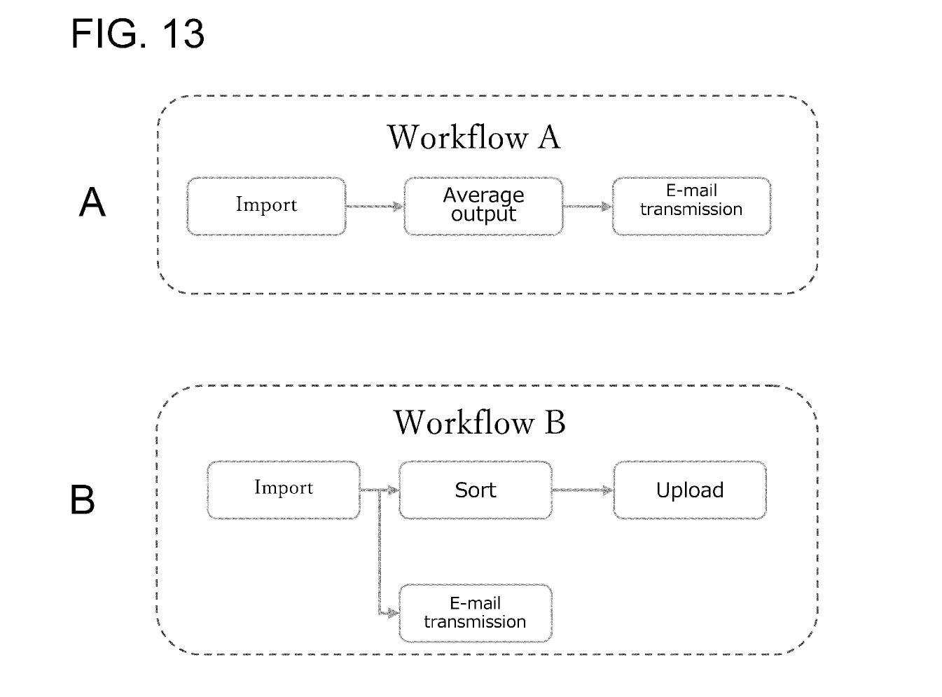

FIG. 13 shows an example of a workflow for a SaaS service such as “flat rate of 10,000 yen/month,” “upper limit workflow: 5,” and “upper limit number of tasks that can be set: 100,” This figure shows the flow of tasks for the set workflows “A” and “B.” In this example, additional costs such as “100 yen/time” may be charged for specific tasks such as sending e-mails.

In such cases, it is possible to set the aggregation unit for users, groups, apparatuses, organizations, and workflows from the viewpoint of the customer, and to perform cross-tabulation. It is also possible to set the output unit to output the number of executions of workflows or specific tasks in a specific period, or the percentage of executions. Otherwise, it is possible to output the number of executions of tasks included in workflows in a specific period, the number of workflows that include tasks, or the like. In such case, it is also possible to set to exclude tasks, which are not executed by conditional branching.

For example, in workflow “B” in FIG. 13, if a task such as “Sort” or “Upload” is executed after import, the “Mail Send” task is not be executed and therefore is not be included in the usage data 300 and is not be counted.

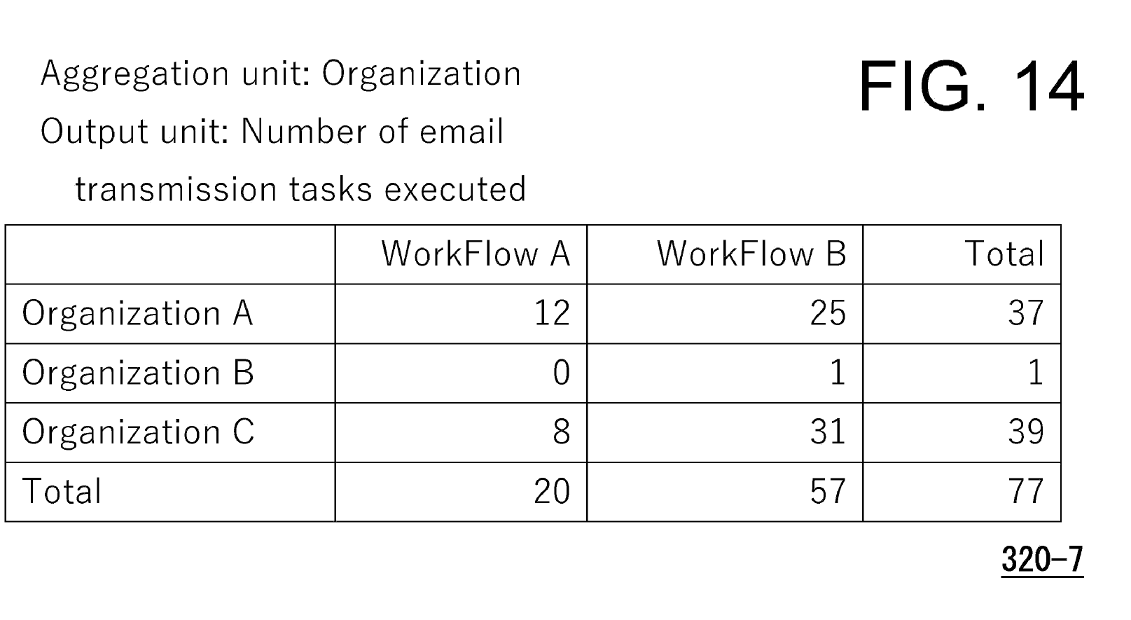

FIG. 14 is an example of output data 320-7, which is aggregated by the viewpoint of the customer, with the aggregation unit being workflow and organization, and the output unit being the number of e-mail transmission tasks executed. As mentioned above, in the workflow “B,” tasks that are executed without sending e-mail are not aggregated.

Note that it is also possible to set even more detailed output units for specific tasks. For example, in the case of a task that sends e-mail, it may be possible to not only count the number of e-mails sent, but also to count the number of e-mails sent to specific domains, the type of e-mail sent, the open rate, or the like. In such cases, the open rate may only be counted by the administrator such as the parent provider.

With the above, the aggregation management process according to the embodiment of the present disclosure is ended.

As configured in this way, the following effects can be obtained.

In typical technologies, there are cases where problems arise when aggregation is performed regardless of the relationships between users. For example, there is a possible competitive relationship between customers and dealers, dealers and other dealers, and dealers and their subordinate sub-dealers, and there are customers, sub-dealers, and dealers who do not want to disclose customer information. Even in such cases, when data from customers, sub-dealers, and dealers are acquired by higher-level sub-dealers, dealers, and providers, or the like, and aggregated data is generated, they are disadvantages. As such, typical technologies are unable to perform aggregation appropriately according to the relationships between users.

On the other hand, the image forming system X according to the present disclosure is a management system having a plurality of image forming apparatuses 2 and a management server 1 that aggregates usage data 300 related to use of service of the plurality of image forming apparatuses 2 for the plurality of users. Each of the plurality of image forming apparatuses 2 is provided with a data transmission unit 200 that transmits usage data 300 related to the use of services by users; and the management server 1 is provided with a data acquisition unit 100 that acquires usage data 300 from the plurality of image forming apparatuses 2, a tree classification unit 110 that classifies each of the plurality of users in a tree structure, a submission management unit 120 that submits or denies the usage data 300 acquired by the data acquisition unit 100 according to the relationship between the user submitting the usage data 300 classified by the tree classification unit 110 and the user acquiring the usage data 300, and an aggregation unit 130 that outputs aggregated data 320 that is aggregated only from the use data 300 permitted to submit by the submission management unit 120 and presents it to the terminal 3 of the user acquiring the use data 300.

By configuring it in this way, it is possible to tabulate appropriately according to the relationship between users. In other words, while performing the aggregation, customers, sub-dealers, dealers, and the like, can refuse to be the target of report output by denying to submit the usage data 300, and then the aggregation can be performed.

Further, in the management server 1 according to the embodiment of the present disclosure, the submission management unit 120 denies the submission of the usage data 300 when the user submitting the usage data 300 and the user acquiring the usage data 300 are in a competitive relationship.

By configuring in this way, in the wholesale business, information on competing submitting customers, sub-dealers, and dealers is not be easily disclosed to acquiring sub-dealers, dealers, and providers in a competitive relationship. In other words, it is possible to respond to customers, sub-dealers and dealers who do not want to release customer information when there is a competitive relationship.

In addition, in typical technologies, in terms of accuracy or system requirements, the granularity of the aggregation is fine in terms of metered billing and usage aggregation, but billing may be charged in units with a large granularity. For example, even if the aggregation within the system is in units of bytes, the billing may be in units of GB. In addition, in cases such as metered billing with no upper limit on usage, the amount of usage used by the tenant can be enormous. In such cases, even if it is output as data as it is, it may be difficult to read.

In contrast, in the management server 1 according to the embodiment of the present disclosure, the aggregation unit 130 outputs the aggregated data 320 at a granularity may set in accordance with the relationship, and the granularity may set based on the viewpoint of a customer or a dealer.

By configuring in this way, it is possible to output data in the desired unit of granularity for customers and dealers who are unable to aggregate data, externally. This makes it possible to visualize overall usage and sales status. In other words, in SaaS that aggregates metered billing and usage, it is possible to present important information in an easy-to-understand manner from the customer’s viewpoint and the dealer’s viewpoint by selecting the granularity of the report and aggregating it.

Further, in the management server 1 according to the embodiment of the present disclosure, the service is a service for managing the image forming apparatus 2, and the usage data 300 may be data related to the billing and usage of the image forming apparatus 2.

By configuring in this way, it is possible to appropriately aggregate data according to the relationship between users in a fleet system, or the like, for the image forming apparatus 2.

Further, in the management server 1 of the embodiments of the present disclosure, the usage data 300 may be data for tasks in a workflow.

By configuring in this way, it is possible to perform aggregation by task. That is, even if the number of executed workflows differs from the number of tasks included in the workflow, aggregating by task can be performed. Thus, it is possible to perform aggregation, which is dependent on the environment of the customer or the dealer. Therefore, it is possible to perform more appropriate aggregation.

Furthermore, by aggregating the number of tasks included in the workflow and the number of tasks actually executed, it is also possible to obtain information about the amount of money charged by providers of services such as the public telephone network, and the actual usage efficiency, or the like.

### Other embodiments

In addition, in the above-mentioned embodiment, an example is described in which a sub-dealer denies to submit the usage data 300 to the parent provider.

However, on the management server 1, the aggregation unit 130 may aggregate the usage data 300 without denying to submit it to the administrator of the tree structure.

By configuring in this way, even if the customer, sub-dealer, and dealer denies to submit the usage data 300 that needs to be aggregated on the system, the provider can still acquire and aggregate it. For example, if the parent provider has management authority, it is also possible to obtain the usage data 300 so that it cannot be viewed by the dealer.

In such case, the aggregated data 320 may be configured so that it is not presented to customers, sub-dealers, and dealers in a competitive relationship, for example, by making it unavailable for viewing. Alternatively, it is also possible to configure the output of a report in which the columns are filled in above-mentioned “N/A,” or the like, for the user in the competitive relationship.

Further, in the above-mentioned embodiment, although the aggregation of services such as fleet of image forming systems is described as SaaS, aggregation of other services is also possible.

Furthermore, the aggregation of the present disclosure can also be applied to information processing apparatuses other than image forming apparatuses. For example, tasks related to network scanners, document management systems, or the like, can be aggregated. In addition, it is also possible to perform aggregation of usage and access to image forming apparatus 2 and management server 1 from the user’s terminal including the terminal 3.

Further, in the above-mentioned embodiment, an example of setting the relationship between users such as customers, sub-dealers, dealers, and providers (parent providers) is described. However, it is also possible to perform aggregation by units such as organizations, apparatuses, groups, and the like, within users. In such case, it is also possible to deny to submit the usage data 300 by those units.

Further, in the above-mentioned embodiment, an example describes the output of aggregated data 320, which is aggregated only from the submitted usage data 300.

However, it is also possible to perform aggregation of the usage data 300, which has been denied to submit, by adding random values to increase anonymity, using past values, or using statistical estimates.

By configuring in this way, the aggregated data 320 that is numerically appropriate overall can be output even if there is the use data 300 that has been denied to submit.

Further, in the above-mentioned embodiment, an example in which a single management server 1 is used is described. However, a management server by using plurality of apparatuses or virtual servers, or the like, can be configured depending on the unit of aggregation. Furthermore, it is also possible to configure a system in which intermediate servers are prepared for each user and use data 300 is aggregated and aggregated on these servers.

Further, in the above-mentioned embodiment, an example of providing SaaS on the management server 1 in the cloud is described, but it is also possible to provide it on the image forming apparatus 2 itself or on a server on the intranet.

In the terminology used in this specification, the singular forms “a”, “an” and “the” also include the plural forms unless the context clearly indicates otherwise.

It goes without saying that the configuration and operation of the above-mentioned embodiments are examples, and that they can be changed and executed as appropriate within the scope of not deviating from the purpose of the present disclosure.

What is claimed is:

1. A management server that aggregates usage data related to use of a service by a plurality of users, comprising:
a tree classification unit configured to classify each of the plurality of users in a tree structure;
a submission management unit configure to permit or deny submission of the usage data according to relationship between a user submitting the usage data and a user acquiring the usage data as classified by the tree classification unit; and
an aggregation unit configured to output aggregated data that is aggregated only from the usage data permitted to submit by the submission management unit for presentation to the user acquiring the usage data.

2. The management server according to claim 1, wherein
the submission management denies the submission of the usage data when the user submitting the usage data and the user acquiring the usage data are in a competitive relationship.

3. The management server according to claim 1, wherein
the aggregation unit outputs the aggregated data at a granularity set in accordance with the relationship, wherein
the granularity is set based on viewpoint of a customer or a dealer.

4. The management server according to claims claim 1, wherein
the service is a service for managing an image forming apparatus, and
the usage data is data relating to billing and usage of the image forming apparatus.

5. The management server according to claims claim 1, wherein
the usage data is data related to a task in a workflow.

6. A management system having a plurality of image forming apparatuses and a management server that aggregates usage data related to use of a service of the plurality of image forming apparatuses by a plurality of users,
each of the plurality of image forming apparatuses comprising:
a data transmission unit configured to transmit the usage data; and
the management server comprising:
a data acquisition unit configured to acquire the usage data from the plurality of image forming apparatuses,
a tree classification unit configured to classify each of the plurality of users in a tree structure,
a submission management unit configured to submit or deny the usage data acquired by the data acquisition unit according to relationship between the user submitting the usage data classified by the tree classification unit and the user acquiring the usage data, and
an aggregation unit configured to output aggregated data that is aggregated only from the usage data permitted to submit by the submission management unit and present to a terminal for the user acquiring the usage data.

7. The management system according to claim 6, wherein
the submission management denies the submission of the usage data when the user submitting the usage data and the user acquiring the usage data are in a competitive relationship.

8. The management system according to claim 6, wherein
the aggregation unit outputs the aggregated data at a granularity set in accordance with the relationship, wherein
the granularity is set based on viewpoint of a customer or a dealer.

9. The management system according to claim 6, wherein
the service is a service for managing an image forming apparatus, and
the usage data is data relating to billing and usage of the image forming apparatus.

10. The management system according to claim 6, wherein
the usage data is data related to a task in a workflow.

11. An aggregation management method executed by a management server that aggregates usage data related to use of a service by a plurality of users, the method comprising the steps of:
classifying each of the plurality of users into a tree structure;
permitting or denying the submission of the usage data according to relationship between a user submitting the usage data and a user acquiring the usage data as classified; and
outputting aggregated data that is aggregated only from the usage data permitted to submit for presentation to the user acquiring the usage data.

12. The aggregation management method according to claim 11, further comprising the step of:
denying the submission of the usage data when the user submitting the usage data and the user acquiring the usage data are in a competitive relationship.

13. The aggregation management method according to claim 11, further comprising the step of:
outputting the aggregated data at a granularity set in accordance with the relationship; wherein
the granularity is set based on viewpoint of a customer or a dealer.

14. The aggregation management method according to claim 11, wherein
the service is a service for managing an image forming apparatus, and
the usage data is data relating to billing and usage of the image forming apparatus.

15. The aggregation management method according to claim 11, wherein
the usage data is data related to a task in a workflow.
